(19) United States
(12) Patent Application Publication
(10) Pub. No.: US 2026/0106561 A1
(43) Pub. Date: Apr. 16, 2026

(54) VECTOR CONTROL FOR A MULTI-PHASE SYSTEM

(71) Applicant: Infineon Technologies AG, Neubiberg (DE)

(72) Inventors: Fang Qi, Starnberg (DE); Ali El Hafni, Unterhaching (DE); Jan-Christian Westphal, Ilmenau (DE); Stefan Huell, Munich, Ramersdorf-Perlach (DE)

(21) Appl. No.: 18/917,728

(22) Filed: Oct. 16, 2024

(51) Int. Cl. H02P 21/24; H02P 21/14

(52) U.S. Cl. CPC H02P 21/24; H02P 21/14; H02P 2201/13; H02P 2209/09

(57) ABSTRACT

A circuit for vector control includes a shifting pattern selector, a shifting signal generator, and driver circuitry. The shifting pattern selector is configured to select, based on a hysteresis value, an angle of a current voltage reference, and an angle of a previous voltage reference, a first shifting pattern from a plurality of shifting pattern. The shifting signal generator is configured to generate, based on the selection of the first shifting pattern and the current voltage reference, a first pulse modulated signal for a first phase and a second pulse modulated signal for a second phase. The driver circuitry is configured to control switching circuitry to generate, based on the first pulse modulated signal, a first phase signal for the first phase and to generate, based on the second pulse modulated signal, a second phase signal for the second phase.

### TECHNICAL FIELD

This disclosure relates to circuits and techniques for controlling a multi-phase system, and more specifically, for example, circuits and techniques for generating a pulse modulated signal for controlling a three-phase electric motor.

### BACKGROUND

Operation of a multi-phase system may be performed by a controller circuit. A controller circuit controls switching circuitry to provide power from a supply to each phase of the multi-phase system based on a desired amplitude and angle of a voltage reference for vector control.

### SUMMARY

In general, this disclosure is directed to techniques for generating pulse modulated signals for controlling a multi-phase system (e.g., a three-phase electrical motor) while ensuring and/or improving an accuracy of voltage and/or current measurements of phases of the multi-phase system. For example, a circuit may select a first shifting pattern from a plurality of shifting patterns for controlling the multi-phase system based on an angle of a current voltage reference (e.g., an instant voltage reference) and based further on a hysteresis value and an angle of a previous voltage reference. Using the hysteresis value and the angle of the previous voltage reference may help to ensure that the circuit does not change the shifting pattern near an edge between two sectors (e.g., within a range of angles defined by the hysteresis value). Changing the shifting pattern near an edge between two sectors may increase an amount of error in measurements of an electrical characteristic (e.g., phase current), thereby potentially reducing stability of the multi-phase system and/or potentially increasing a harmonic distortion.

In some examples, the disclosure describes a circuit for vector control of a multi-phase system including a shifting pattern selector, a shifting signal generator, and driver circuitry. The shifting pattern selector is configured to select, based on a hysteresis value, an angle of a current voltage reference, and an angle of a previous voltage reference, a first shifting pattern from a plurality of shifting patterns for controlling the multi-phase system. The shifting signal generator is configured to generate, based on the selection of the first shifting pattern and the current voltage reference, a first pulse modulated signal for a first phase of the multi-phase system and a second pulse modulated signal for a second phase of the multi-phase system. The driver circuitry is configured to control switching circuitry to generate, based on the first pulse modulated signal, a first phase signal for the first phase and to generate, based on the second pulse modulated signal, a second phase signal for the second phase.

In some examples, this disclosure describes a method for vector control of a multi-phase system, the method comprising selecting, based on a hysteresis value, an angle of a current voltage reference, and an angle of a previous voltage reference, a first shifting pattern from a plurality of shifting patterns for controlling the multi-phase system and generating, based on the selection of the first shifting pattern and the current voltage reference, a first pulse modulated signal for a first phase of the multi-phase system and a second pulse modulated signal for a second phase of the multi-phase system. The method further includes controlling switching circuitry to generate, based on the first pulse modulated signal, a first phase signal for the first phase and to generate, based on the second pulse modulated signal, a second phase signal for the second phase.

In some examples, this disclosure describes a system for vector control of a multi-phase system, the system including switching circuitry, a shifting pattern selector, a shifting signal generator, and driver circuitry. The shifting pattern selector is configured to select, based on a hysteresis value, an angle of a current voltage reference, and an angle of a previous voltage reference, a first shifting pattern from a plurality of shifting patterns for controlling the multi-phase system. The shifting signal generator is configured to generate, based on the selection of the first shifting pattern and the current voltage reference, a first pulse modulated signal for a first phase of the multi-phase system and a second pulse modulated signal for a second phase of the multi-phase system. The driver circuitry is configured to control the switching circuitry to generate, based on the first pulse modulated signal, a first phase signal for the first phase and to generate, based on the second pulse modulated signal, a second phase signal for the second phase.

Details of these and other examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system for controlling a multi-phase system, in accordance with one or more techniques of this disclosure.

FIG. 2 is a conceptual schematic illustrating an example system for controlling a multi-phase system, in accordance with one or more techniques of this disclosure.

FIG. 3 is a graph plot illustrating an example of a switching pattern for vector control, in accordance with one or more techniques of this disclosure.

FIG. 4 is a graph plot illustrating an example voltage reference for vector control, in accordance with one or more techniques of this disclosure.

FIG. 5 is a conceptual control diagram illustrating blind areas of symmetric switching, in accordance with one or more techniques of this disclosure.

FIG. 6 is a graph plot illustrating an example of asymmetric switching, in accordance with one or more techniques of this disclosure.

FIG. 7 is a graph plot illustrating an example of current measurement error at sector borders, in accordance with one or more techniques of this disclosure.

FIG. 8 is a graph plot illustrating example current measurements using asymmetric switching, in accordance with one or more techniques of this disclosure.

FIG. 9 is a conceptual diagram illustrating example sectors for controlling a multi-phase system, in accordance with one or more techniques of this disclosure.

FIG. 10 is a first conceptual diagram illustrating an example of a hysteresis value applied to sectors for controlling a multi-phase system, in accordance with one or more techniques of this disclosure.

FIG. 11 is a second conceptual diagram illustrating an example of a hysteresis value applied to sectors for controlling a multi-phase system, in accordance with one or more techniques of this disclosure.

FIG. 12 is a graph plot illustrating example current measurements and a selected sector, in accordance with one or more techniques of this disclosure.

FIG. 13 is a conceptual vector control diagram illustrating an example mapping of a long pulse, middle pulse, and short pulse to sectors, in accordance with one or more techniques of this disclosure.

FIG. 14 is a flowchart illustrating an example process, in accordance with one or more techniques of the disclosure.

### DETAILED DESCRIPTION

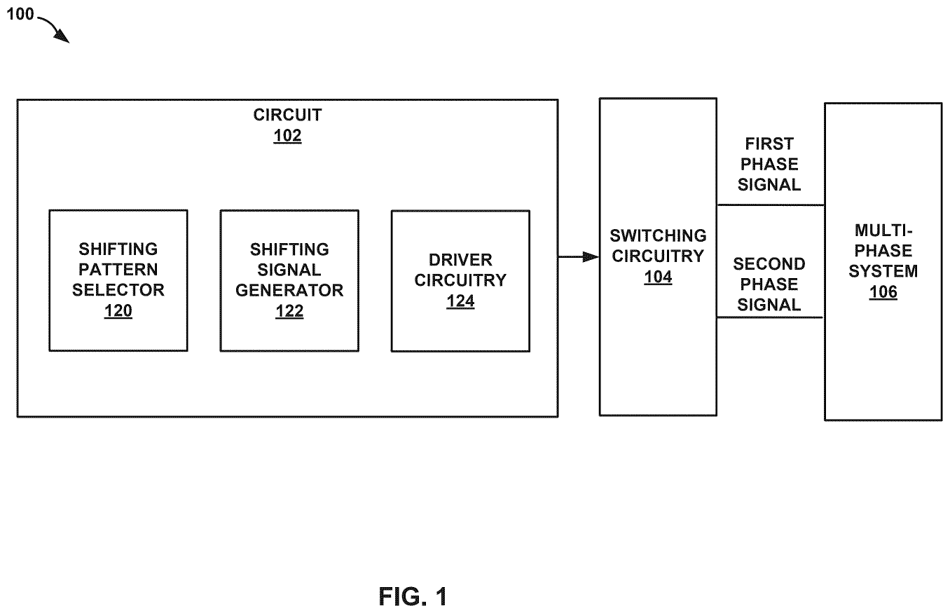

FIG. 1 is a block diagram illustrating an example system 100 for controlling a multi-phase system 106, in accordance with one or more techniques of this disclosure. As illustrated in the example of FIG. 1, system 100 may include a circuit 102, switching circuitry 104, and multi-phase system 106. Circuit 102 may include shifting pattern selector 120, a shifting signal generator 122, and driver circuitry 124. While the example of FIG. 1 includes only two phases, some examples may include more than two phases. For example, switching signal generator 120 may optionally control a third phase of multi-phase system 106.

Circuit 102 may be configured for vector control of multi-phase system 106. For example, circuit 102 may be configured to control, based on a current voltage reference (e.g., a voltage vector for a particular point of time) for multi-phase system 106 and pre-defined switching patterns for the vector control, an activation of switching elements of switching circuitry 104. Circuit 102 may determine the current voltage reference (e.g., an angle and magnitude) based on a shunt current for multi-phase system 106. For example, circuit 102 may optionally include an electrical signal detector configured to determine the shunt current for multi-phase system 106 while driver circuitry 124 controls switching circuitry 104. Circuit 102 may include one or more processors, such as one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

Switching circuitry 104 may be configured to selectively couple a first phase of multi-phase system 106 to a supply or a reference node (e.g., a local ground or earth ground) and to selectively couple a second phase of multi-phase system 106 to the supply or the reference node. In the example of FIG. 1, switching circuitry 104 is controlled by circuit 102, particularly, for example, driver circuitry 124. Examples of switching elements may include, but are not limited to, a silicon-controlled rectifier (SCR), a Field Effect Transistor (FET), and a bipolar junction transistor (BJT). Examples of FETs may include, but are not limited to, a junction field-effect transistor (JFET), a metal-oxide-semiconductor FET (MOSFET), a dual-gate MOSFET, an insulated-gate bipolar transistor (IGBT), any other type of FET, or any combination of the same. Examples of MOSFETS may include, but are not limited to, a depletion mode p-channel MOSFET (PMOS), an enhancement mode PMOS, depletion mode n-channel MOSFET (NMOS), an enhancement mode NMOS, a double-diffused MOSFET (DMOS), any other type of MOSFET, or any combination of the same. Examples of BJTs may include, but are not limited to, PNP, NPN, heterojunction, or any other type of BJT, or any combination of the same. It should be understood that switching elements may be high-side or low-side switching elements. Additionally, switching elements may be voltage-controlled and/or current-controlled. Examples of current-controlled switching elements may include, but are not limited to, gallium nitride (GaN) MOSFETs, BJTs, or other current-controlled elements.

Multi-phase system 106 may comprise any system using at least two phases. Examples of multi-phase system 106 may include a multi-phase electric motor, such as, for example, a three-phase permanent-magnet synchronous motor (PMSM), a three-phase brushless direct current motor (BLDC), or a multi-phase solar inverter. Multi-phase system 106 may operate as only a load to convert electrical energy into mechanical energy, only a generator to convert mechanical energy into electrical energy, or both a load or a generator.

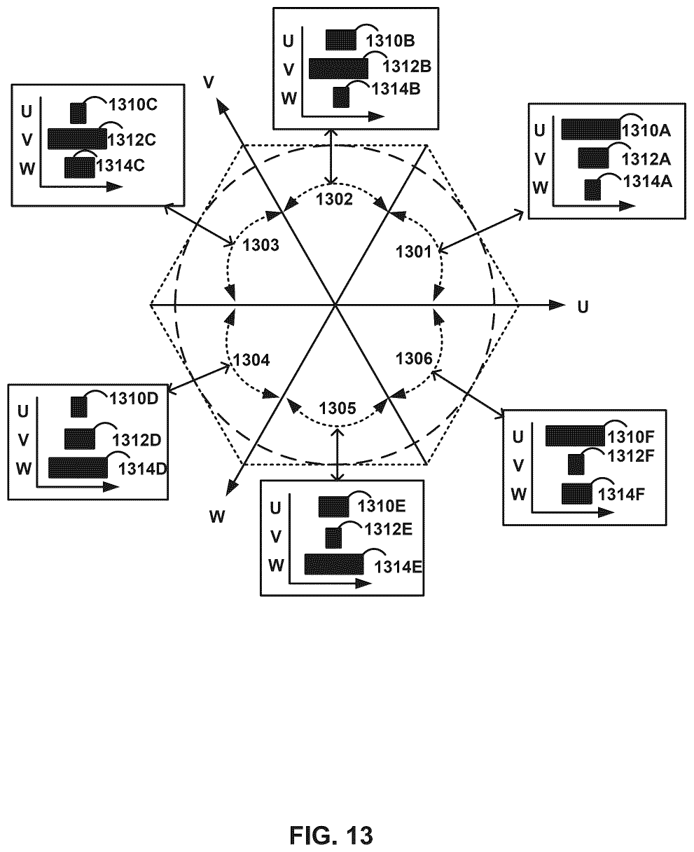

Circuit 102 (e.g., a vector controller implemented in circuit 102) may determine a voltage reference (e.g., a voltage magnitude and an angle) for multi-phase system 106. For example, circuit 102 may generate a current voltage reference and/or previous voltage reference using vector control, also referred to herein as “field-oriented control (FOC).” In some examples, shifting pattern selector 120 may receive, from a vector controller (e.g., implemented in circuitry outside of circuit 102), a current voltage reference and/or previous voltage reference that is generated using vector control. Examples of devices that can use vector control may include, as for example, linear regulators (e.g., proportional-integral (PI) or proportional-integral-derivative (PID)), and/or nonlinear regulators. The previous voltage reference may immediately precede the current voltage reference. As described further herein, circuit 102 may use switching patterns assigned to sectors (e.g., six sectors) of the vector control (see FIG. 13) and/or shifting patterns (e.g., six shifting patterns) to control multi-phase system 106.

In accordance with the techniques of the disclosure, shifting pattern selector 120 may be configured to select a shifting pattern from a plurality of shifting patterns for controlling multi-phase system 106 based on a hysteresis value, an angle of a current voltage reference, and an angle of a previous voltage reference. The hysteresis value may be a preconfigured (e.g., user defined) or predetermined hysteresis value (e.g., determined by circuit 102 or another circuit). For example, shifting pattern selector 120 may determine a rotation direction based on the angle of the current voltage reference and the angle of the previous voltage reference. For instance, shifting pattern selector 120 may determine the rotation direction is positive based on a determination that the angle of the current voltage reference is greater than the angle of the previous voltage reference. Similarly, shifting pattern selector 120 may determine the rotation direction is negative based on a determination that the angle of the current voltage reference is less than the angle of the previous voltage reference.

In the example of FIG. 1, shifting pattern selector 120 may select a first shifting pattern based on a determination that the angle of the current voltage reference satisfies a rotated set of predefined angles for the first shifting pattern. For instance, shifting pattern selector 120 may apply hysteresis to a set of predefined angles for a first sector (e.g., 0 degrees to 60 degrees) of a plurality of sectors to shift the set of predefined angles in the rotation direction (e.g., positive) by the hysteresis value (e.g., 10 degrees) to generate the rotated set of predefined angles for the first shifting pattern. In this instance, shifting pattern selector 120 may select the first shifting pattern based on a determination that an angle of the current voltage reference (e.g., 60 degrees) is within the rotated set of predefined angles assigned to the first shifting pattern (e.g., 10 degrees to 70 degrees). That is, the shifting of the set of predefined angles for the first sector in the rotation direction by the hysteresis value causes the angle of the current voltage reference to be within the rotated set of predefined angles assigned to the first shifting pattern. Using the hysteresis value and the angle of the previous voltage reference may help to ensure that circuit 102 does not change the shifting pattern near an edge between two sectors (e.g., within a range of angles defined by the hysteresis value).

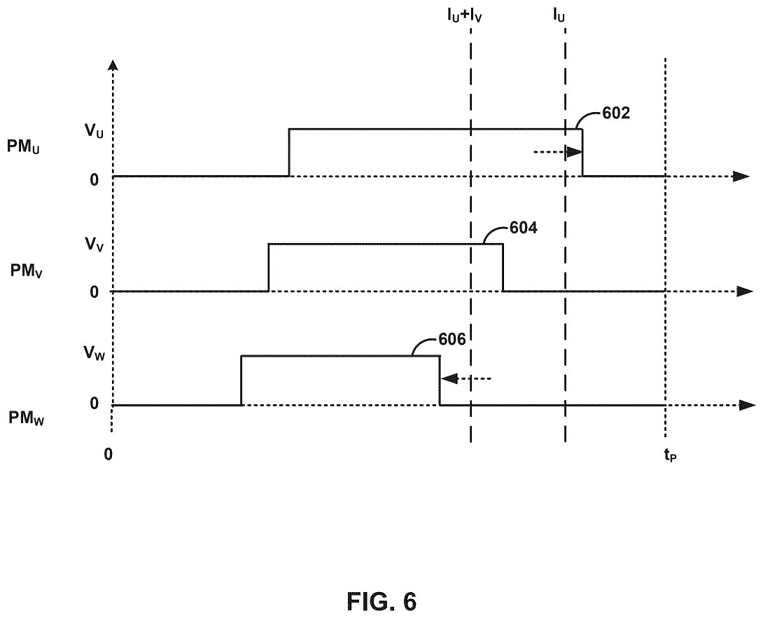

Shifting signal generator 122 may be configured to generate, based on the selection of the first shifting pattern and the current voltage reference, a first pulse modulated signal for a first phase of multi-phase system 106 and a second pulse modulated signal for a second phase of multi-phase system 106. For example, based on a determination that the first pulse modulated signal corresponds to a long pulse in the first shifting pattern and that the second pulse modulated signal corresponds to a short pulse in the first shifting pattern, shifting signal generator 122 may shift the first pulse modulated signal in a first direction and shift the second pulse modulated signal in a second direction that is opposite from the first direction. In this example, shifting signal generator 122 may determine that the first shifting pattern assigns the long pulse to the first pulse modulated signal and that the first shifting pattern assigns the short pulse to the second pulse modulated signal. In this instance, shifting signal generator 122 may add, based on the first pulse modulated signal corresponding to the long pulse, a predetermined amount of time to the first pulse such that the first pulse starts and ends later than prior to shifting (see FIG. 6). Similarly, shifting signal generator 122 may subtract, based on the second pulse modulated signal corresponding to the short pulse, the predetermined amount of time to the second pulse such that the second pulse starts and ends later than prior to shifting (see FIG. 6).

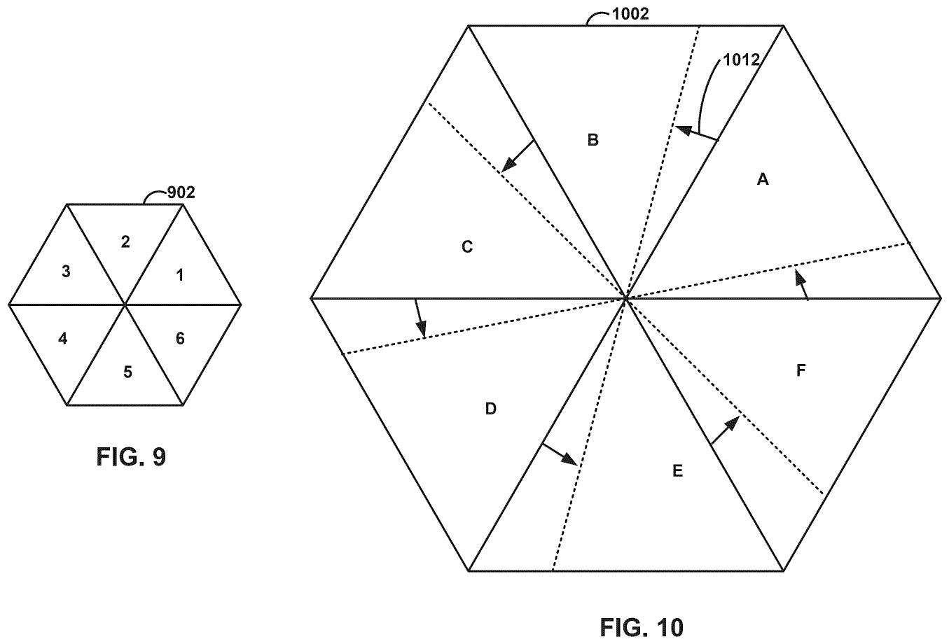

Shifting signal generator 122 may generate the first pulse modulated signal and the second pulse modulated signal based on a respective symmetric switching pattern assigned to each sector of a plurality of sectors for controlling a multi-phase system. For example, shifting signal generator 122 may select, based on the angle of a current voltage reference, a first sector from a plurality of sectors for controlling the multi-phase system. For instance, shifting signal generator 122 may select the first sector in response to determining that the angle of a current voltage reference is within a set of predefined angles for the first sector (see FIG. 9). Shifting signal generator 122 may select, based on the selection of the first sector, a first pulse for the first pulse modulated signal and a second pulse for the second pulse modulated signal. For example, shifting signal generator 122 may determine that a symmetric switching pattern for the first sector assigns a middle pulse to the first pulse modulated signal and that the symmetric switching pattern assigns a short pulse to the second pulse modulated signal. In this example, shifting signal generator 122 may shift, using a shifting pattern, the first pulse in the first pulse modulated signal in the first direction and to shift the second pulse in the second pulse modulated signal in the second direction as described above.

Shifting signal generator 122 may determine whether to shift the first pulse modulated signal and the second pulse modulated signal based on whether the angle of the current voltage reference is within a predefined range of angles from a border formed by two adjacent sections. In response to a determination that the angle of the current voltage reference is within the predefined range of angles from the border, shifting signal generator 122 may shift the first pulse modulated signal in a first direction and shift the second pulse modulated signal in a second direction that is opposite from the first direction. In response, however, to a determination that the angle of the current voltage reference is not within the predefined range of angles from the border, shifting signal generator 122 may refrain from shifting the first pulse modulated signal in the first direction and may refrain from shifting the second pulse modulated signal in the second direction that is opposite from the first direction.

Shifting signal generator 122 may be configured to generate the first pulse modulated signal based on the current voltage reference. For example, shifting signal generator 122 may be configured to set, based on a magnitude of the current voltage reference, a duty cycle of the first pulse modulated signal and/or a duty cycle of the second pulse modulated signal. Additionally, or alternatively, shifting signal generator 122 may be configured to set, based on the magnitude of the current voltage reference, a difference in duration between the long pulse and the short pulse.

Driver circuitry 124 may be configured to control switching circuitry 104 to generate, based on the first pulse modulated signal, a first phase signal for the first phase and to generate, based on the second pulse modulated signal, a second phase signal for the second phase. For example, driver circuitry 124 may be configured to generate the first phase signal to drive one or more switching elements to couple the first phase to a supply (e.g., a DC-link) or a reference node (e.g., ground) based on the first pulse modulated signal. Similarly, driver circuitry 124 may be configured to generate the second phase signal to drive one or more switching elements to couple the second phase to the supply or the reference node based on the second pulse modulated signal.

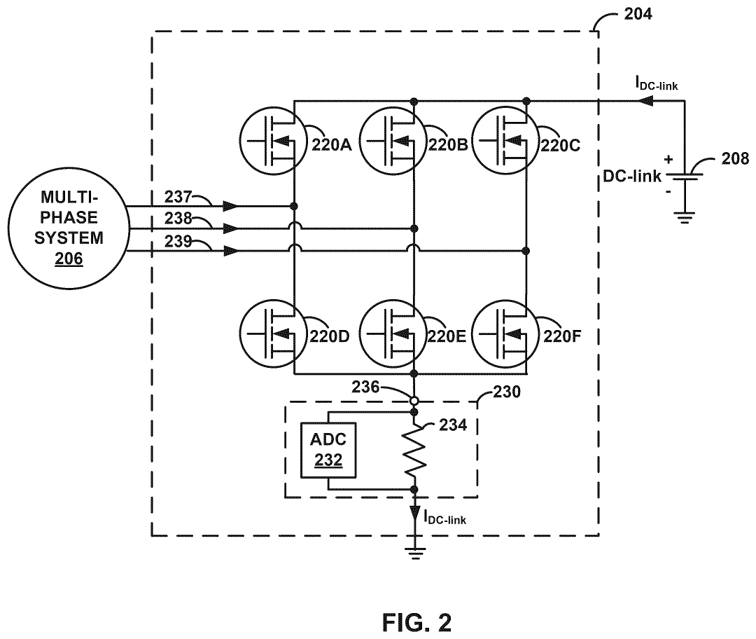

FIG. 2 is a conceptual schematic illustrating an example system for controlling a multi-phase system 206, in accordance with one or more techniques of this disclosure. FIG. 2 is discussed with reference to FIG. 1 for example purposes only. FIG. 2 illustrates multi-phase system 206 as a three-phase electric motor for example purposes only.

Driver circuitry 124 of FIG. 1 may control switching elements 220A-220F (collectively, “switching elements 220”) of switching circuitry 204. Switching circuitry 204 may control a current path (e.g. IDC-link) through switching elements 220. For example, switching elements 220 may connect a first side (e.g., a positive terminal) of a supply 208 (e.g. a DC-link) to multi-phase system 206. Examples of supply 208 may include a direct current (DC) voltage supply. Switching elements 220 may connect multi-phase system 206 to a second side (e.g., a negative terminal or reference terminal) of supply 208.

Electrical signal detector 230 may be configured to determine a shunt current for multi-phase system 206 while driver circuitry 124 of FIG. 1 controls switching circuitry 204 to generate first phase signal 237 and to generate second phase signal 238. For example, electrical signal detector 230 may measure a voltage drop from an input port 236 of electrical signal detector 230 to a reference node (e.g., an earth ground or a voltage reference). The voltage drop may be referred to herein as a voltage response when switching signals are applied. The voltage drop may be generated from the current (e.g. IDC-link) through a resistive shunt 234. Electrical signal detector 230 may be used to measure the resulting voltage response from current routed through a combination of switching elements 220 into input port 236. An analog-to-digital converter (ADC) 232 may be configured to measure a voltage drop resulting from current generated by phase currents 237, 238, 239. Phase current measurements generated by electrical signal detector 230 may be used to control multi-phase system 206 using vector control.

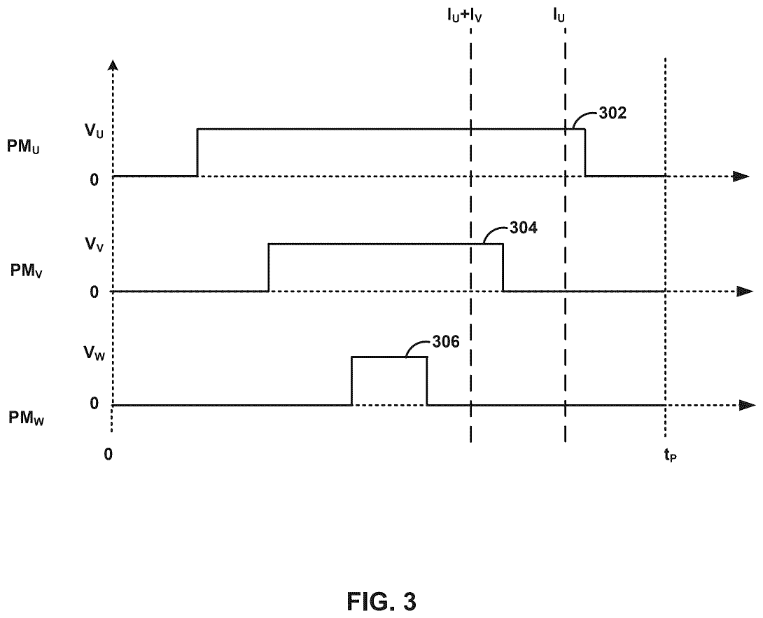

FIG. 3 is a graph plot illustrating an example of a switching pattern for vector control, in accordance with one or more techniques of this disclosure. FIG. 3 is discussed with reference to FIGS. 1-2 for example purposes only. In the example of FIG. 3, the horizontal axis represents time and the vertical axis represents a first pulse modulated signal 302, a second pulse modulated signal 304, and a third pulse modulated signal 306. In symmetric control pattern of FIG. 3 (e.g., a 3-phase center aligned pattern), each one of first pulse modulated signal 302, second pulse modulated signal 304, and third pulse modulated signal 306 is aligned to a center of the switching period.

Electrical signal detector 230 of FIG. 2 may be configured to measure the shunt current twice in a switching period. Electrical signal detector 230 may measure a first sample as a combination of the first phase current and the second phase current (I_{U}+I_{V}). In this example, electrical signal detector 230 may measure a second sample as the first phase current (I_{U}). Based on Kirchhoff's circuit laws (i.e., I_{U}+I_{V}+I_{W}=0), electrical signal detector 230 may reconstruct each one of the three phase currents (I_{U}, I_{V}, I_{W}).

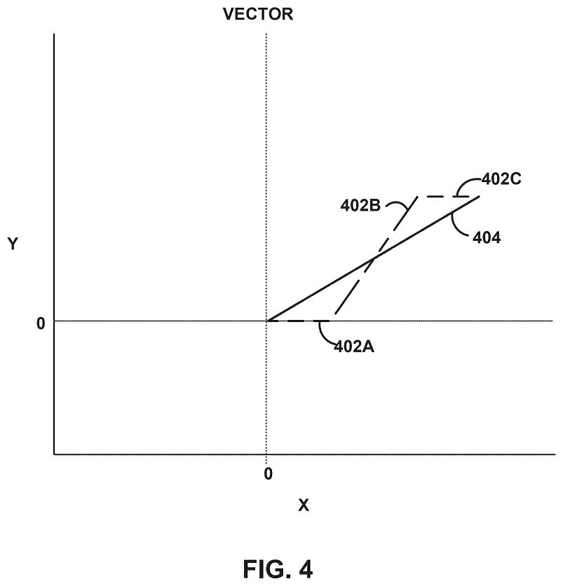

FIG. 4 is a graph plot illustrating an example voltage reference 404 for vector control, in accordance with one or more techniques of this disclosure. FIG. 4 is discussed with reference to FIGS. 1-3 for example purposes only. In the example of FIG. 4, circuit 102 of FIG. 1 controls switching circuitry 104 to transition between switching patterns, where each one of sub-vectors 402A, 402B, 402C corresponds to a voltage vector of a switching pattern. As shown, the sum of the sub-vectors 402A, 402B, 402C results in voltage reference 404. In this way, circuit 102 may generate voltage reference 404 to be different than a single one of the sub-vectors.

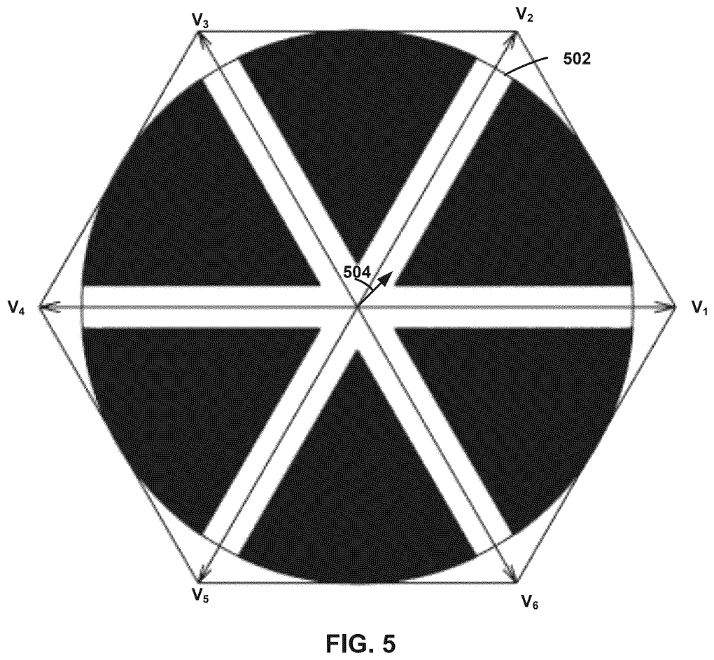

FIG. 5 is a conceptual control diagram illustrating blind areas of symmetric switching, in accordance with one or more techniques of this disclosure. FIG. 5 is discussed with reference to FIGS. 1-4 for example purposes only. Circuit 102 of FIG. 1 may generate a voltage reference 504 by pulse modulated signals (e.g., see FIG. 4). As discussed further with respect to FIG. 6, circuit 102 may not be able to measure the shunt current in blind area 502 (shown as unfilled) of the control circle twice in a single period, which may result in measurement errors.

FIG. 6 is a graph plot illustrating an example of asymmetric switching, in accordance with one or more techniques of this disclosure. FIG. 6 is discussed with reference to FIGS. 1-5 for example purposes only. In the example of FIG. 6, the horizontal axis represent time and the vertical axis represents a first pulse modulated signal 602, a second pulse modulated signal 604, and a third pulse modulated signal 606.

In blind area 502 of FIG. 5, edges of a first pulse modulated signal 602, a second pulse modulated signal 604, and a third pulse modulated signal 606 may move close relative to sampling times, which may result in measurement errors. In asymmetric control pattern of FIG. 6 (e.g., a 3-phase center aligned pattern), shifting signal generator 122 shifts, from the symmetric control pattern of FIG. 3, the long pulse (i.e., first pulse modulated signal 602) to the right and shifts the short pulse (i.e., third pulse modulated signal 606) to the left. In this way, circuit 102 may help to reduce the blind spot of FIG. 5 to more accurately measure a first sample as a combination of the first phase current and the second phase current (I_{U}+I_{V}) and a second sample as the first phase current (I_{U}) compared to systems that do not shift from the symmetric control patterns. Reducing the blind spot may allow circuit 102 to accurately reconstruct each one of the three phase currents (I_{U}, I_{V}, I_{W}) for a larger portion of the control circle than systems that do not shift from the symmetric control patterns. For example, shifting signal generator 122 may increase an amount of measurement time available for an electronic signal detector (e.g., an ADC).

Shifting signal generator 122 may shift based on the angle of the voltage reference. For instance, shifting signal generator 122 may shift from the symmetric control pattern of FIG. 3 based on a determination that the angle of the current voltage reference is within a predefined range of angles from the border (e.g., in a blind spot of FIG. 5). In this instance, shifting signal generator 122 may refrain from shifting from the symmetric control pattern of FIG. 3 based on a determination that the angle of the current voltage reference is not within the predefined range of angles from the border.

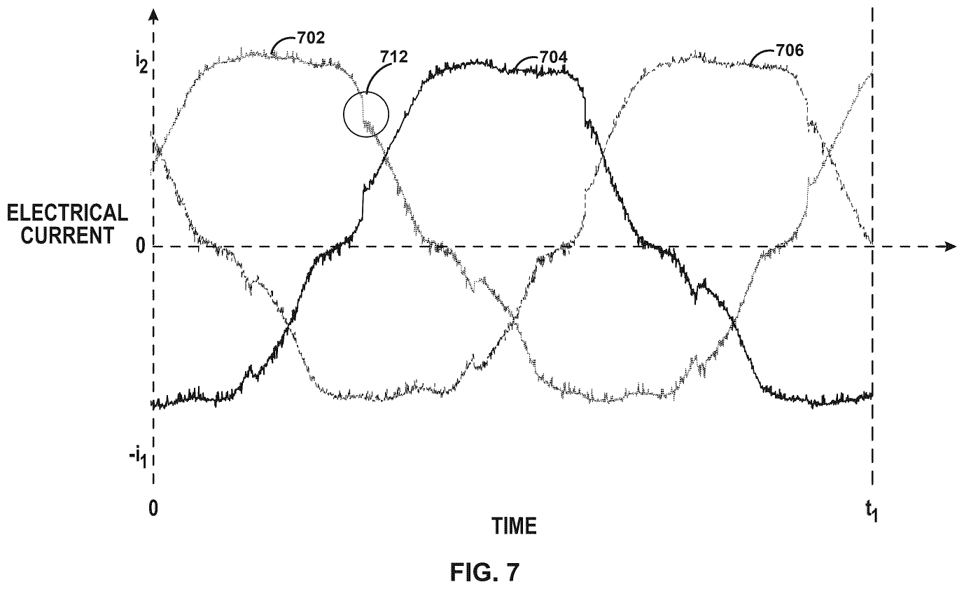

FIG. 7 is a graph plot illustrating an example of current measurement error at sector borders, in accordance with one or more techniques of this disclosure. FIG. 7 is discussed with reference to FIGS. 1-6 for example purposes only. In the example of FIG. 7, the horizontal axis represent time and the vertical axis represents a first reconstructed phase current 702, a second reconstructed phase current 704, and a third reconstructed phase current 706. FIG. 7 illustrates voltage-to-frequency control on a low inductance motor (e.g., L=0.125 mH) where actual current occurring at multi-phase system 106 is smooth. In the example of FIG. 7, the reconstructed phase current (i.e., first reconstructed phase current 702, second reconstructed phase current 704, and third reconstructed phase current 706) with asymmetric switching includes current measurement error jumps 712 at section borders. An interaction between the measurement error from current measurement error jumps 712 and current proportional-integral control may result in ringing, where the selected sector repetitively changes between two sectors. Moreover, the current-to-frequency control operation on the low inductance motor may result in acoustic noise emission (e.g., 3× electrical frequency).

To determine each phase current in a three-phase system, circuit 102 may sample two currents and reproduce the current using Kirchhoff's circuit laws (i.e., Iu+Iv+Iw=0) for any given instant in time. Example reasons of current measurement error jumps 712 of the measured phase currents may include, for example, an assumption in a single-shunt scheme that currents are sampled at the same time, which is not true, and/or that phase currents are constant during a single cycle, which may lead to a larger error as an inductance of a motor decreases. Current measurement error in a single-shunt scheme may be hardware-independent and/or measurement-pattern-dependent.

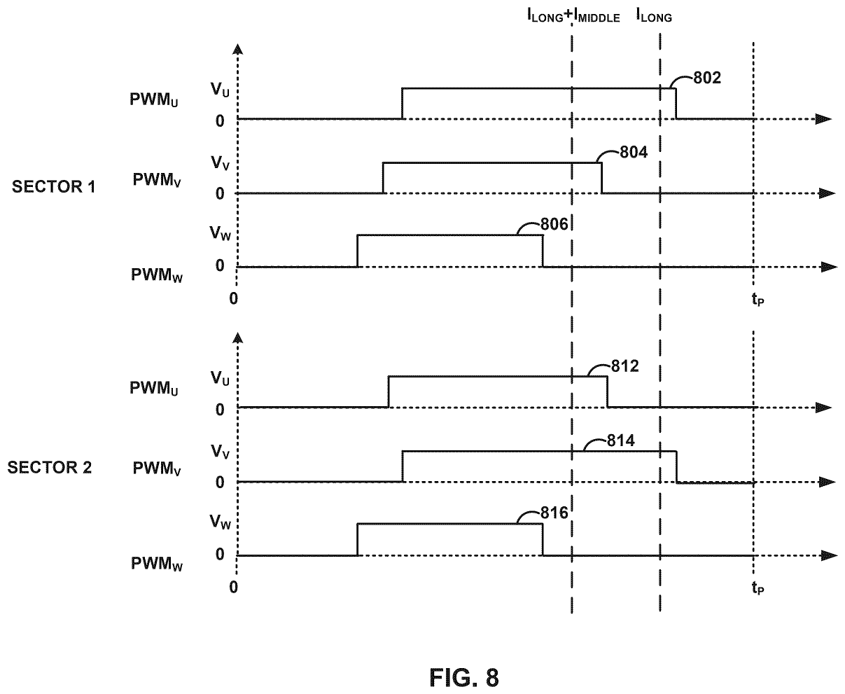

FIG. 8 is a graph plot illustrating example current measurements using asymmetric switching, in accordance with one or more techniques of this disclosure. FIG. 8 is discussed with reference to FIGS. 1-7 for example purposes only. In the example of FIG. 8, the horizontal axis represent time and the vertical axis represents, for a previous voltage reference, a first pulse modulated signal 802, a second pulse modulated signal 804, and a third pulse modulated signal 806 and, for a current voltage reference, a first pulse modulated signal 812, a second pulse modulated signal 814, and a third pulse modulated signal 816.

In the example of FIG. 8, shifting signal generator 122 shifts, from the symmetric switching pattern of FIG. 3, first pulse modulated signal 802 to the right and shifts third pulse modulated signal 806 to the left to help to reduce a blind spot. In this example, circuit 102 may measure a first sample (I_{LONG}+I_{MIDDLE}) as a combination of the long pulse (i.e., first pulse modulated signal 802) and the middle pulse (i.e., second pulse modulated signal 802) for the previous voltage reference. However, changing both the switching pattern and the shifting pattern when changing from sector 1 to sector 2 may result in undesirable error in measurements of an electrical characteristic (e.g., phase current). An example of a change in the sampled currents when changing sectors is shown in Table 1.

TABLE 1

| Sector Number | First Sample | Second Sample |
|---|---|---|
| Sector 1 | U + V | U |
| Sector 2 | U + V | V |

The sudden change in the shifting pattern may lead to non-linear jumps of the measurement error. This non-linear behavior may form a positive feedback loop with a PI controller, which may result in an oscillation of the phase currents. An oscillation of the phase currents may result in undesirable acoustic noise.

FIG. 9 is a conceptual diagram illustrating example sectors 902 for controlling a multi-phase system, in accordance with one or more techniques of this disclosure. FIG. 9 is discussed with reference to FIGS. 1-8 for example purposes only. Each sector (illustrated as 1, 2, 3, 4, 5, 6) of sectors 902 may have a unique mapping of the long/middle/short pulse. For example, sector 1 may have a mapping of U/V/W and sector 2 may have a mapping of V/U/W. An example of a complete mapping is shown below in Table 2.

FIG. 10 is a first conceptual diagram illustrating an example of a hysteresis value applied to sectors for controlling a multi-phase system, in accordance with one or more techniques of this disclosure. FIG. 10 is discussed with reference to FIGS. 1-9 for example purposes only. In the example of FIG. 10, shifting pattern selector 120 may provide shifting pattern hysteresis to help to prevent frequent jumping of the shifting pattern. For example, shifting pattern selector 120 may decouple the shifting pattern change with the sector change.

In accordance with the techniques of the disclosure, shifting pattern selector 120 may be configured to select a shifting pattern (e.g., A, B, C, D, E, or F of FIG. 10) for controlling multi-phase system 106 based on a hysteresis value, an angle of a current voltage reference, and an angle of a previous voltage reference. For example, shifting pattern selector 120 may determine a rotation direction (e.g., positive or counterclockwise) based on the angle of the current voltage reference and the angle of the previous voltage reference. In this example, shifting pattern selector 120 may select a first shifting pattern based on a determination that the angle of the current voltage reference satisfies a rotated set of predefined angles assigned to the first shifting pattern. The rotated set of predefined angles may include a set of predefined angles for a first sector of a plurality of sectors shifted in the rotation direction by the hysteresis value. For instance, shifting pattern selector 120 may apply hysteresis 1012 to a set of predefined angles for the first sector (e.g., 0 degrees to 60 degrees) to shift the set of predefined angles in the rotation direction (e.g., positive) by the hysteresis value (e.g., 10 degrees).

In this instance, shifting pattern selector 120 may select the first shifting pattern (e.g., ‘A’) based on a determination that an angle of the current voltage reference is within a rotated set of predefined angles for the first shifting pattern (e.g., ‘A’). That is, an angle of the current voltage reference may be within a set of predefined angles for a second sector (e.g., sector 2 of FIG. 9) and the angle of a previous voltage reference may be within a set of predefined angles for the first sector (e.g., sector 1 of FIG. 9). In this example, however, shifting pattern selector 120 may select the first shifting pattern (e.g., ‘A’) when using applying hysteresis. In contrast, shifting pattern selector 120 may select sector 2 for determining the switching pattern (e.g., which phase is assigned a long pulse, middle pulse, and/or short pulse). Using the hysteresis value and the angle of the previous voltage reference to determine a shifting pattern may help to ensure that circuit 102 does not change the shifting pattern near an edge between two sectors (e.g., within a range of angles defined by the hysteresis value). While the example of FIG. 10 referred to the first shifting pattern as ‘A’, in other examples, the first shifting pattern may refer to one of B-F or another shifting pattern for a different set of shifting patterns.

As used herein, a shifting pattern may define, for each phase, a respective shift. For example, shifting patterns 1002 may assign left, none, or right as shown in Table 2.

TABLE 2

| SHIFTING | | | |
|---|---|---|---|
| PATTERN | RIGHT | NONE | LEFT |
| A | Phase U | Phase V | Phase W |
| B | Phase V | Phase U | Phase W |
| C | Phase V | Phase W | Phase U |
| D | Phase W | Phase V | Phase U |
| E | Phase W | Phase U | Phase V |
| F | Phase U | Phase W | Phase V |

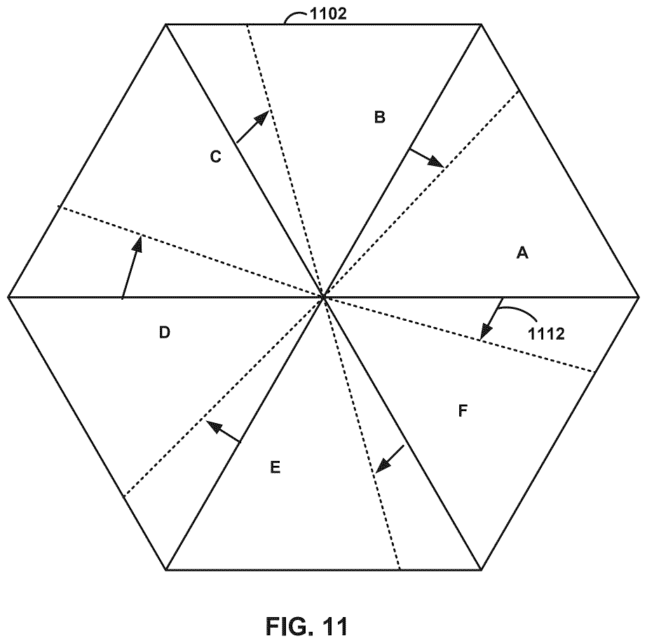

FIG. 11 is a second conceptual diagram illustrating an example of a hysteresis value applied to sectors for controlling a multi-phase system, in accordance with one or more techniques of this disclosure. FIG. 11 is discussed with reference to FIGS. 1-10 for example purposes only.

In the example of FIG. 11, shifting pattern selector 120 may determine a rotation direction (e.g., negative or clockwise) based on the angle of the current voltage reference and the angle of the previous voltage reference. In this example, shifting pattern selector 120 may select a first shifting pattern of shifting patterns 1102 based on a determination that the angle of the current voltage reference satisfies a set of predefined angles for the first sector shifted in the rotation direction by the hysteresis value. For instance, shifting pattern selector 120 may apply hysteresis 1112 to a set of predefined angles for the first sector (e.g., 0 degrees to 60 degrees) to shift the set of predefined angles in the rotation direction (e.g., negative) by the hysteresis value (e.g., 10 degrees). In this instance, shifting pattern selector 120 may select the first shifting pattern (e.g., sector ‘A’) based on a determination that an angle of the current voltage reference is within a rotated set of predefined angles for the first shifting pattern shifted (e.g., sector ‘A’). In this way, shifting pattern selector 120 may select add or subtract the hysteresis value to a set of predefined angles for a particular sector to help to ensure that circuit 102 does not change the shifting pattern near an edge between two sectors (e.g., within a range of angles defined by the hysteresis value). While the example of FIG. 11 referred to the first shifting pattern as ‘A’, in other examples, the first shifting pattern may refer to one of B-F or another shifting pattern for a different set of shifting patterns.

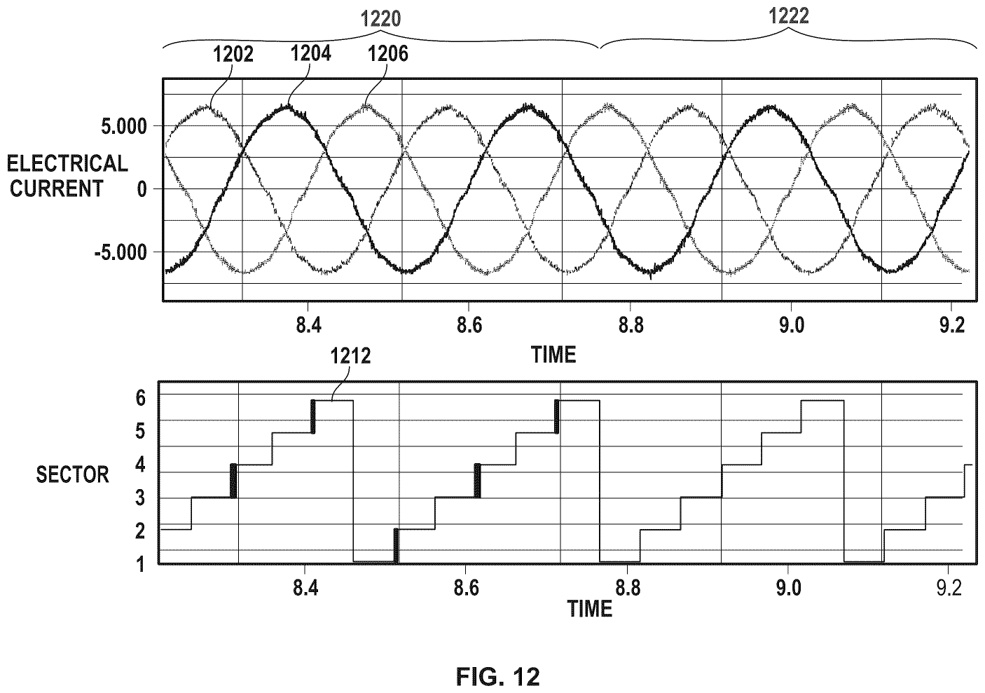

FIG. 12 is a graph plot illustrating example current measurements and a selected sector, in accordance with one or more techniques of this disclosure. FIG. 12 is discussed with reference to FIGS. 1-11 for example purposes only. In the example of FIG. 12, the horizontal axis represent time and the vertical axis represents a first phase signal 1202, a second phase signal 1204, a third phase signal 1206, and a selected sector 1212.

During time range 1220, shifting pattern selector 120 may perform asymmetric switching and refrain from performing hysteresis to sets of predefined angles for sectors to select a shifting pattern, which may result in selected sector 1212 repetitively changing between two sectors. During time range 1222, however, shifting pattern selector 120 may perform hysteresis to sets of predefined angles for sectors to select a shifting pattern, which may help to ensure that selected sector 1212 does not repetitively change between two sectors. In this way, shifting pattern selector 120 may help to improve a stability of controlling the circuit compared to systems that do not select a shifting pattern based on the hysteresis value.

FIG. 13 is a conceptual vector control diagram illustrating an example mapping of a long pulse, middle pulse, and short pulse to sectors, in accordance with one or more techniques of this disclosure. FIG. 13 is discussed with reference to FIGS. 1-12 for example purposes only.

In the example of FIG. 13, the field orientation of a rotor is divided into sections 1301, 1302, 1303, 1304, 1305, and 1306. Section 1301 assigns first pulse modulated signal 1310A, second pulse modulated signal 1312A, and third pulse modulated signal 1314A to control the current in a “U” phase winding, a “V” phase winding, and a “W” phase winding, respectively. Similarly, section 1302 assigns first pulse modulated signal 1310B, second pulse modulated signal 1312B, and third pulse modulated signal 1314B to control the current in a “U” phase winding, a “V” phase winding, and a “W” phase winding, respectively. Section 1303 assigns first pulse modulated signal 1310C, second pulse modulated signal 1312C, and third pulse modulated signal 1314C to control the current in a “U” phase winding, a “V” phase winding, and a “W” phase winding, respectively and section 1304 assigns first pulse modulated signal 1310D, second pulse modulated signal 1312D, and third pulse modulated signal 1314D to control the current in a “U” phase winding, a “V” phase winding, and a “W” phase winding, respectively. Further, section 1305 assigns first pulse modulated signal 1310E, second pulse modulated signal 1312E, and third pulse modulated signal 1314E to control the current in a “U” phase winding, a “V” phase winding, and a “W” phase winding, respectively and section 1306 assigns first pulse modulated signal 1310F, second pulse modulated signal 1312F, and third pulse modulated signal 1314F to control the current in a “U” phase winding, a “V” phase winding, and a “W” phase winding, respectively.

Shifting signal generator 122 may assign a symmetric switching pattern to each sector, where the symmetric switching pattern defines, for each phase, a pulse length (e.g., maximum/long, middle, and minimum/short). For example, shifting signal generator 122 may assign PWM_{Max} (e.g., a maximum/long pulse), PWM_{Mid} (e.g., a middle pulse), and PWM_{Min} (e.g., a minimum/short pulse) as shown in Table 3. Using PWM_{Max}, PWM_{Mid}, and PWM_{Min}, may allow shifting signal generator 122 to reduce a complexity of circuit 102.

TABLE 3

| Sector | PWM_{Max} | PWM_{Mid} | PWM_{Min} |
|---|---|---|---|
| 1 | Phase U | Phase V | Phase W |
| 2 | Phase V | Phase U | Phase W |
| 3 | Phase V | Phase W | Phase U |
| 4 | Phase W | Phase V | Phase U |
| 5 | Phase W | Phase U | Phase V |
| 6 | Phase U | Phase W | Phase V |

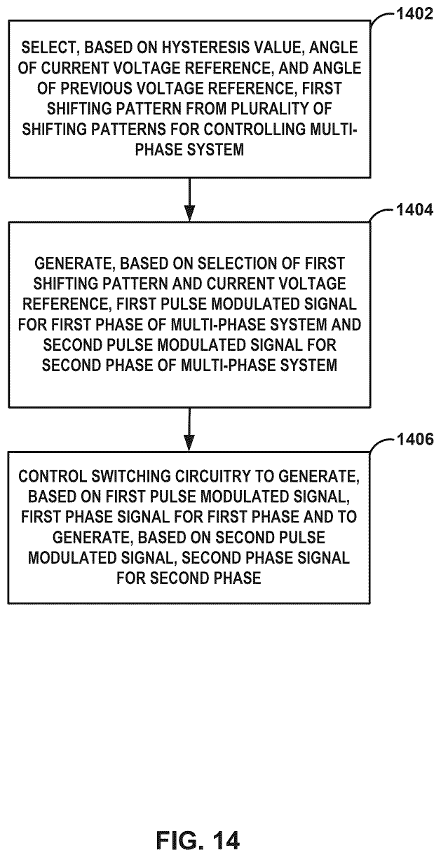

FIG. 14 is a flowchart illustrating an example process, in accordance with one or more techniques of the disclosure. FIG. 14 is discussed with reference to FIGS. 1-13 for example purposes only.

Shifting pattern selector 120 may select, based on a hysteresis value, an angle of a current voltage reference, and an angle of a previous voltage reference, a shifting pattern from a plurality of shifting patterns for controlling multi-phase system 106 (1402). For example, shifting pattern selector 120 may determine a rotation direction based on the angle of the current voltage reference and the angle of the previous voltage reference. In this example, shifting pattern selector 120 may select the first shifting pattern based on a determination that the angle of the current voltage reference satisfies a set of predefined angles for the first sector shifted in the rotation direction by the hysteresis value. The angle of the current voltage reference may be within a set of predefined angles for a second sector of the plurality of sectors and the angle of the previous voltage reference may be within a set of predefined angles for the first sector. The set of predefined angles for the first sector may include a 60 degree angle. For example, the set of predefined angles for the first sector may include: a first angle between 0 degrees and 60 degrees, a second angle between 60 degrees and 120 degrees, a third angle between 120 degrees and 180 degrees, a fourth angle between 180 degrees and 240 degrees, a fifth angle between 240 degrees and 300 degrees, or a sixth angle between 300 degrees and 360 degrees.

Shifting signal generator 122 may generate, based on the selection of the first shifting pattern and the current voltage reference, a first pulse modulated signal for a first phase of the multi-phase system and a second pulse modulated signal for a second phase of the multi-phase system (1404). For example, shifting signal generator 122 may, based on the selection of the first shifting pattern, shift the first pulse modulated signal in a first direction and shift the second pulse modulated signal in a second direction that is opposite from the first direction. For instance, shifting signal generator 122 may, based on the first shifting pattern mapping the first modulated signal (e.g., phase U) to the first direction and mapping the second modulated signal (e.g., phase W) to the second direction, shift the first pulse modulated signal in the first direction (e.g., the right) and shift the second pulse modulated signal in a second direction (e.g., the left).

Driver circuitry 124 may control switching circuitry 104 to generate, based on the first pulse modulated signal, a first phase signal for the first phase and to generate, based on the second pulse modulated signal, a second phase signal for the second phase (1406). The switching circuitry 104 may include a three-phase inverter circuit. In some examples, multi-phase system 106 may include a three-phase electric motor.

In some examples, an electrical signal detector may determine a shunt current for multi-phase system 106 while driver circuitry 124 controls switching circuitry 104 to generate the first phase signal and to generate the second phase signal. For example, electrical signal detector 230 of FIG. 2 may determine a shunt current for multi-phase system 206.

The following clauses may demonstrate one or more aspects of the disclosure.

Clause 1: A circuit for vector control of a multi-phase system, the circuit comprising: a shifting pattern selector configured to select, based on a hysteresis value, an angle of a current voltage reference, and an angle of a previous voltage reference, a first shifting pattern from a plurality of shifting patterns for controlling the multi-phase system; a shifting signal generator configured to generate, based on the selection of the first shifting pattern and the current voltage reference, a first pulse modulated signal for a first phase of the multi-phase system and a second pulse modulated signal for a second phase of the multi-phase system; and driver circuitry configured to control switching circuitry to generate, based on the first pulse modulated signal, a first phase signal for the first phase and to generate, based on the second pulse modulated signal, a second phase signal for the second phase.

Clause 2: The circuit of clause 1, wherein to select the first shifting pattern, the shifting pattern selector is configured to: determine a rotation direction based on the angle of the current voltage reference and the angle of the previous voltage reference; and select the first shifting pattern based on a determination that the angle of the current voltage reference satisfies a rotated set of predefined angles assigned to the first shifting pattern, the rotated set of predefined angles comprising a set of predefined angles for a first sector of a plurality of sectors shifted in the rotation direction by the hysteresis value.

Clause 3: The circuit of clause 2, wherein the angle of the current voltage reference is within a set of predefined angles for a second sector of the plurality of sectors and wherein the shifting of the set of predefined angles for the first sector in the rotation direction by the hysteresis value causes the angle of the current voltage reference to be within the rotated set of predefined angles assigned to the first shifting pattern.

Clause 4: The circuit of clauses 2-3, wherein the set of predefined angles for the first sector comprises a 60 degree angle.

Clause 5: The circuit of clauses 2-4, wherein the set of predefined angles for the first sector comprises: a first angle between 0 degrees and 60 degrees; a second angle between 60 degrees and 120 degrees; a third angle between 120 degrees and 180 degrees;

a fourth angle between 180 degrees and 240 degrees; a fifth angle between 240 degrees and 300 degrees; or a sixth angle between 300 degrees and 360 degrees.

Clause 6: The circuit of clauses 1-5, wherein to generate the first pulse modulated signal and the second pulse modulated signal, the shifting signal generator is configured to: based on the selection of the first shifting pattern, shift the first pulse modulated signal in a first direction and shift the second pulse modulated signal in a second direction that is opposite from the first direction.

Clause 7: The circuit of clause 6, wherein to generate the first pulse modulated signal and the second pulse modulated signal, the shifting signal generator is configured to: select, based on the angle of a current voltage reference, a first sector from a plurality of sectors for controlling the multi-phase system; and select, based on the selection of the first sector, a first pulse for the first pulse modulated signal and a second pulse for the second pulse modulated signal, wherein to shift, the shifting signal generator is configured to shift the first pulse in the first pulse modulated signal in the first direction and to shift the second pulse in the second pulse modulated signal in the second direction.

Clause 8: The circuit of clauses 1-7, further comprising an electrical signal detector configured to determine a shunt current for the multi-phase system while the driver circuitry controls the switching circuitry to generate the first phase signal and to generate the second phase signal.

Clause 9: The circuit of clauses 1-8, wherein the switching circuitry comprises a three-phase inverter circuit; and wherein the multi-phase system comprises a three-phase electric motor.

Clause 10: A method for vector control of a multi-phase system, the method comprising: selecting, based on a hysteresis value, an angle of a current voltage reference, and an angle of a previous voltage reference, a first shifting pattern from a plurality of shifting patterns for controlling the multi-phase system; generating, based on the selection of the first shifting pattern and the current voltage reference, a first pulse modulated signal for a first phase of the multi-phase system and a second pulse modulated signal for a second phase of the multi-phase system; and controlling switching circuitry to generate, based on the first pulse modulated signal, a first phase signal for the first phase and to generate, based on the second pulse modulated signal, a second phase signal for the second phase.

Clause 11: The method of clause 10, wherein selecting the first sector comprises: determining a rotation direction based on the angle of the current voltage reference and the angle of the previous voltage reference; and selecting the first shifting pattern based on a determination that the angle of the current voltage reference satisfies a rotated set of predefined angles assigned to the first shifting pattern, the rotated set of predefined angles comprising a set of predefined angles for a first sector of a plurality of sectors shifted in the rotation direction by the hysteresis value.

Clause 12: The method of clauses 10-11, wherein the angle of the current voltage reference is within a set of predefined angles for a second sector of the plurality of sectors and wherein the angle of the previous voltage reference is within a set of predefined angles for the first sector.

Clause 13: The method of clauses 11-12, wherein the set of predefined angles for the first sector comprises a 60 degree angle.

Clause 14: The method of clauses 11-13, wherein a set of predefined angles for the first sector comprises: a first angle between 0 degrees and 60 degrees; a second angle between 60 degrees and 120 degrees; a third angle between 120 degrees and 180 degrees; a fourth angle between 180 degrees and 240 degrees; a fifth angle between 240 degrees and 300 degrees; or a sixth angle between 300 degrees and 360 degrees.

Clause 15: The method of clauses 10-14, wherein generating the first pulse and the second pulse comprises: based on the selection of the first shifting pattern, shifting the first pulse modulated signal in a first direction and shift the second pulse modulated signal in a second direction that is opposite from the first direction.

Clause 16: The method of clause 15, wherein generating the first pulse and the second pulse comprises: selecting, based on the angle of a current voltage reference, a first sector from a plurality of sectors for controlling the multi-phase system; and selecting, based on the selection of the first sector, a first pulse length for the first pulse modulated signal and a second pulse length for the second pulse modulated signal, wherein the shifting comprises shifting the first pulse in the first pulse modulated signal in the first direction and shifting the second pulse in the second pulse modulated signal in the second direction.

Clause 17: The method of clauses 10-16, further comprising determining a shunt current for the multi-phase system while controlling the switching circuitry to generate the first phase signal and to generate the second phase signal.

Clause 18: The method of clauses 10-17, wherein the switching circuitry comprises a three-phase inverter circuit and wherein the multi-phase system comprises a three-phase electric motor.

Clause 19: A system for vector control of a multi-phase system, the system comprising: switching circuitry; a shifting pattern selector configured to select, based on a hysteresis value, an angle of a current voltage reference, and an angle of a previous voltage reference, a first shifting pattern from a plurality of shifting patterns for controlling the multi-phase system; a shifting signal generator configured to generate, based on the selection of the first shifting pattern and the current voltage reference, a first pulse modulated signal for a first phase of the multi-phase system and a second pulse modulated signal for a second phase of the multi-phase system; and driver circuitry configured to control the switching circuitry to generate, based on the first pulse modulated signal, a first phase signal for the first phase and to generate, based on the second pulse modulated signal, a second phase signal for the second phase.

Clause 20: The system of clause 19, further comprising the multi-phase system.

Various aspects have been described in the disclosure. These and other aspects are within the scope of the following claims.

What is claimed is:

1. A circuit for vector control of a multi-phase system, the circuit comprising:
a shifting pattern selector configured to select, based on a hysteresis value, an angle of a current voltage reference, and an angle of a previous voltage reference, a first shifting pattern from a plurality of shifting patterns for controlling the multi-phase system;
a shifting signal generator configured to generate, based on the selection of the first shifting pattern and the current voltage reference, a first pulse modulated signal for a first phase of the multi-phase system and a second pulse modulated signal for a second phase of the multi-phase system; and
driver circuitry configured to control switching circuitry to generate, based on the first pulse modulated signal, a first phase signal for the first phase and to generate, based on the second pulse modulated signal, a second phase signal for the second phase.

2. The circuit of claim 1, wherein to select the first shifting pattern, the shifting pattern selector is configured to:
determine a rotation direction based on the angle of the current voltage reference and the angle of the previous voltage reference; and
select the first shifting pattern based on a determination that the angle of the current voltage reference satisfies a rotated set of predefined angles assigned to the first shifting pattern, the rotated set of predefined angles comprising a set of predefined angles for a first sector of a plurality of sectors shifted in the rotation direction by the hysteresis value.

3. The circuit of claim 2, wherein the angle of the current voltage reference is within a set of predefined angles for a second sector of the plurality of sectors and wherein the shifting of the set of predefined angles for the first sector in the rotation direction by the hysteresis value causes the angle of the current voltage reference to be within the rotated set of predefined angles assigned to the first shifting pattern.

4. The circuit of claim 2, wherein the set of predefined angles for the first sector comprises a 60 degree angle.

5. The circuit of claim 2, wherein the set of predefined angles for the first sector comprises:
a first angle between 0 degrees and 60 degrees;
a second angle between 60 degrees and 120 degrees;
a third angle between 120 degrees and 180 degrees;
a fourth angle between 180 degrees and 240 degrees;
a fifth angle between 240 degrees and 300 degrees; or
a sixth angle between 300 degrees and 360 degrees.

6. The circuit of claim 1, wherein to generate the first pulse modulated signal and the second pulse modulated signal, the shifting signal generator is configured to:
based on the selection of the first shifting pattern, shift the first pulse modulated signal in a first direction and shift the second pulse modulated signal in a second direction that is opposite from the first direction.

7. The circuit of claim 6, wherein to generate the first pulse modulated signal and the second pulse modulated signal, the shifting signal generator is configured to:
select, based on the angle of a current voltage reference, a first sector from a plurality of sectors for controlling the multi-phase system; and
select, based on the selection of the first sector, a first pulse for the first pulse modulated signal and a second pulse for the second pulse modulated signal,
wherein to shift, the shifting signal generator is configured to shift the first pulse in the first pulse modulated signal in the first direction and to shift the second pulse in the second pulse modulated signal in the second direction.

8. The circuit of claim 1, further comprising an electrical signal detector configured to determine a shunt current for the multi-phase system while the driver circuitry controls the switching circuitry to generate the first phase signal and to generate the second phase signal.

9. The circuit of claim 1,
wherein the switching circuitry comprises a three-phase inverter circuit; and
wherein the multi-phase system comprises a three-phase electric motor.

10. A method for vector control of a multi-phase system, the method comprising:
selecting, based on a hysteresis value, an angle of a current voltage reference, and an angle of a previous voltage reference, a first shifting pattern from a plurality of shifting patterns for controlling the multi-phase system;
generating, based on the selection of the first shifting pattern and the current voltage reference, a first pulse modulated signal for a first phase of the multi-phase system and a second pulse modulated signal for a second phase of the multi-phase system; and
controlling switching circuitry to generate, based on the first pulse modulated signal, a first phase signal for the first phase and to generate, based on the second pulse modulated signal, a second phase signal for the second phase.

11. The method of claim 10, wherein selecting the first sector comprises:
determining a rotation direction based on the angle of the current voltage reference and the angle of the previous voltage reference; and
selecting the first shifting pattern based on a determination that the angle of the current voltage reference satisfies a rotated set of predefined angles assigned to the first shifting pattern, the rotated set of predefined angles comprising a set of predefined angles for a first sector of a plurality of sectors shifted in the rotation direction by the hysteresis value.

12. The method of claim 11, wherein the angle of the current voltage reference is within a set of predefined angles for a second sector of the plurality of sectors and wherein the shifting of the set of predefined angles for the first sector in the rotation direction by the hysteresis value causes the angle of the current voltage reference to be within the rotated set of predefined angles assigned to the first shifting pattern.

13. The method of claim 11, wherein the set of predefined angles for the first sector comprises a 60 degree angle.

14. The method of claim 11, wherein the set of predefined angles for the first sector comprises:
a first angle between 0 degrees and 60 degrees;
a second angle between 60 degrees and 120 degrees;
a third angle between 120 degrees and 180 degrees;
a fourth angle between 180 degrees and 240 degrees;
a fifth angle between 240 degrees and 300 degrees; or
a sixth angle between 300 degrees and 360 degrees.

15. The method of claim 10, wherein generating the first pulse and the second pulse comprises:
based on the selection of the first shifting pattern, shifting the first pulse modulated signal in a first direction and shift the second pulse modulated signal in a second direction that is opposite from the first direction.

16. The method of claim 15, wherein generating the first pulse and the second pulse comprises:
selecting, based on the angle of a current voltage reference, a first sector from a plurality of sectors for controlling the multi-phase system; and
selecting, based on the selection of the first sector, a first pulse length for the first pulse modulated signal and a second pulse length for the second pulse modulated signal,
wherein the shifting comprises shifting the first pulse in the first pulse modulated signal in the first direction and shifting the second pulse in the second pulse modulated signal in the second direction.

17. The method of claim 10, further comprising determining a shunt current for the multi-phase system while controlling the switching circuitry to generate the first phase signal and to generate the second phase signal.

18. The method of claim 10, wherein the switching circuitry comprises a three-phase inverter circuit and wherein the multi-phase system comprises a three-phase electric motor.

19. A system for vector control of a multi-phase system, the system comprising:
switching circuitry;
a shifting pattern selector configured to select, based on a hysteresis value, an angle of a current voltage reference, and an angle of a previous voltage reference, a first shifting pattern from a plurality of shifting patterns for controlling the multi-phase system;
a shifting signal generator configured to generate, based on the selection of the first shifting pattern and the current voltage reference, a first pulse modulated signal for a first phase of the multi-phase system and a second pulse modulated signal for a second phase of the multi-phase system; and
driver circuitry configured to control the switching circuitry to generate, based on the first pulse modulated signal, a first phase signal for the first phase and to generate, based on the second pulse modulated signal, a second phase signal for the second phase.

20. The system of claim 19, further comprising the multi-phase system.
